(19) United States
(12) Patent Application Publication
(10) Pub. No.: US 2004/0007319 A1
(43) Pub. Date: Jan. 15, 2004

(54) Cold seal adhesive-receptive, tamper evident untreated cavitated film

(76) Inventors: JoAnn H. Squier, Bloomfield, NY (US); David R Williams, Fairport, NY (US)

Correspondence Address: EXXONMOBIL CHEMICAL COMPANY, P O BOX 2149, BAYTOWN, TX, 77522-2149, US

(21) Appl. No.: 10/192,106

(22) Filed: Jul. 10, 2002

(51) Int. Cl. B32B 31/00

(52) U.S. Cl. 156/277; 428/131; 53/411

(57) ABSTRACT

A polymeric film structure having a cavitated skin layer with a cold seal adhesive applied thereto. The cold seal adhesive may be applied to the cavitated layer in the absence of pretreatment or precoating. When used in packaging applications, the film structure provides a tamper evident seal. This same film structure may also be used in pressure sensitive labeling applications without a releasable liner.

### BACKGROUND OF THE INVENTION

The present invention relates to polymeric film structures used in packaging and labeling applications and, more particularly, to a polymeric film structure having a cavitated skin layer with cold seal adhesive coated thereon.

Polymeric film structures are used in many commercial packaging applications, including the packaging of food products. These food packaging applications often utilize a cold seal adhesive to seal a package surrounding a product, e.g. a candy bar, the package being formed from a polymeric film structure. As will be appreciated by those skilled in the art, cold seal adhesive will seal to itself when two such adhesive surfaces are brought into intimate contact with each other. In this regard, the cold seal adhesive is typically located on only one outer surface of the film structure, the other outer surface of the structure typically being printed.

It will be recognized that there are least two drawbacks associated with this known packaging technology. First, the film surface which will receive the cold seal adhesive must usually be pretreated (e.g. flame treatment, corona treatment) and/or precoated, thereby adding a processing step which increases the manufacturing cost for the film structure. Second, in these known packaging applications, the bond between the cold seal adhesive and the polymeric film structure is typically stronger that the internal cohesive bond of the adhesive itself. Thus, failure typically occurs within the adhesive layer. In terms of packaging applications, it may then be difficult to ensure that a package has not been opened and then subsequently resealed.

The use of polymeric film structures in pressure sensitive label applications is also known in the prior art. These labels are often formed from what is commonly referred to as a labelstock. This labelstock typically includes a polymeric film structure, an adhesive adhered to an outer surface of the film structure, and a peelable releasable liner covering the adhesive. The outer surface upon which the adhesive is applied is generally pretreated and/or precoated in some manner to enhance the adhesion of the adhesive thereto. It will be appreciated that the need to pretreat/precoat the outer surface of the film structure and the need to use a releasable liner increase the cost of the labelstock.

There is therefore a need in the art for an improved polymeric film structure for use in packaging applications which utilize a cold seal adhesive. This improved film structure would ideally eliminate the necessity for pretreating/precoating the outer adhesive-receiving surface of the structure and would also provide evidence of tampering if a sealed package is subsequently opened. There is also a need in the art for an improved labelstock, the improved labelstock not requiring pretreating/precoating of the adhesive-receiving surface and not requiring the use of a releasable liner.

### SUMMARY OF THE INVENTION

The present invention provides a polymeric film structure that includes a cavitated skin layer, the outer surface of which is coated at least in part with a cold seal adhesive. In one embodiment, the cold seal adhesive-coated outer surface is unmodified, i.e. not pretreated or precoated. In another embodiment, the film structure includes an opposing indicia-receiving skin layer which may further include an antiblock agent and/or a slip agent.

The polymeric film structure preferably includes a core layer, and also preferably includes a first tie layer positioned between the core layer and the cavitated skin layer. Moreover, the polymeric film structure preferably includes a second tie layer and an indicia-receiving skin layer, the second tie layer being positioned between the core layer and the indicia-receiving skin layer and being located on the opposite side of the core layer from the first tie layer.

The present invention also provides a method of packaging a product which reveals subsequent tampering, the method including the steps of: (a) providing a polymeric film structure having a cavitated skin layer, the cavitated skin layer having an outer surface coated at least in part with a cold seal adhesive; (b) wrapping the film structure around a product; and (c) sealing the film structure around the product by contacting a first portion of the cold seal adhesive with a second portion of the cold seal adhesive to form a sealed film structure enclosing the product whereby opening of the sealed film structure results in visible delamination of the cavitated skin layer thus providing evidence of tampering.

The present invention further provides a method of labeling a product, the method including the steps of (a) providing a polymeric film structure having a cavitated skin layer and an opposing indicia-receiving skin layer, the cavitated skin layer having an outer surface coated with a cold seal adhesive; (b) applying printed indicia to the indicia-receiving surface to provide a pressure sensitive label; and (c) pressing the adhesive-coated cavitated skin layer against the product whereby the label adheres to the product.

### DETAILED DESCRIPTION OF THE INVENTION

It has been discovered herein that cold seal adhesive can be applied directly to a cavitated layer of a polymeric film structure in the absence of pretreatment and/or precoating. It has further been discovered that the internal cohesive strength of a typical cold seal adhesive is greater than the cohesive strength of the cavitated layer, thus providing a tamper-evident seal particularly useful in packaging applications involving food products. Particularly, it has been discovered that a polymeric film structure having a cavitated skin layer with cold seal adhesive applied thereto can be used in packaging application wherein visible evidence of tampering/opening of the sealed packages is desirable.

As will be understood by those skilled in the art, the elimination of the need to pretreat/precoat the adhesive-receiving surface of a film structure facilitates the manufacturing process and thus reduces costs. It will also be understood that the use of a tamper-evident package, i.e. one in which the opening of a sealed package results in at least partial delamination of the film structure, would be desirable in many food packaging applications.

The polymeric film structure of the present invention preferably includes at least two layers, e.g. a substrate and a cavitated skin layer. The two or more layers are coextruded to form a multilayer film structure, which is subsequently oriented using any of the well known processes for biaxial stretching the film. In this regard, a cavitating agent is added to the skin layer prior to extrusion whereby orientation of the extruded structure causes cavitation of such skin layer. The coextruded structure may be uniaxially or biaxially oriented. Preferably, the coextruded structure is stretched from about 3.5 to about 6.0 times in the machine direction and from about 7 to about 10 times in the transverse direction.

The substrate may be formed from any polyolefin, for example, the substrate may include a core layer formed from a polyolefin produced by the Ziegler/Natta or metallocene catalyzed processes, such as for instance, a straight chain polypropylene or polyethylene. In one embodiment, the core layer is formed from a polypropylene homopolymer. Polypropylene homopolymers suitable for use in the core layer may include isotactic polypropylene (e.g. film grade) or any highly crystalline polypropylene (HCPP). In a second embodiment, the core layer is formed from a polyethylene polymer. In a third embodiment, the core layer is formed from a copolymer of ethylene and propylene. In a fourth embodiment, the core layer is formed from a terpolymers of ethylene, propylene and butylene. In a fifth embodiment, the core layer is formed from a blend of any of the above polymers, copolymers and/or terpolymers. The core layer may include a cavitating agent, and may further include one or more whitening agents.

In one embodiment, the core layer has a caliper thickness of from about about 1 mil to about 10 mils. In another embodiment, the core layer has a caliper thickness of from about 3 mils to about 5 mils.

In a further embodiment, the core layer comprises at least about 15 percent by weight of the total film. In another further embodiment, the core layer comprises at least about 30 percent by weight of the total film. In still another embodiment, the core layer comprises at least about 50 percent by weight of the total film. In yet another embodiment, the core layer comprises at least about 70 percent by weight of the total film.

The cavitated skin layer is preferably formed from a polymeric material and a cavitating agent. The cavitated skin layer may be formed from any polymeric material, such as for instance, any one or more of the following polymers: polyethylene methyl acrylic acid, polyethylene ethyl acrylic acid, polyethylene methyl acrylate, acrylonitrile butadiene styrene polymer, nylon, polybutylene, polystyrene, polyurethane, polysulfone, polyvinyl chloride, polyethylene, polypropylene, polycarbonate, polypentene, styrene maleic anhydride polymer, styrene acrylonitrile polymer, ionomers based on sodium or zinc salts of ethylene/methacrylic acid, polymethacrylates, fluoropolymers, polyacrylonitriles, and thermoplastic polyesters. The polymeric material is preferably a polyolefin.

In one embodiment, the cavitated skin layer is formed from a polypropylene homopolymer. These polypropylene homopolymers may include isotactic polypropylene, highly crystalline polypropylene (HCPP) or high density polypropylene (HDPP). In another particular embodiment, the cavitated skin layer is formed from a polyethylene homopolymer. In yet another embodiment, the cavitated skin layer is formed from a propylene-ethylene copolymer, a propylene-butene copolymer, a propylene-1-pentene copolymer, a propylene-1-hexene copolymer or a propylene-4-methyl-1-pentene copolymer.

The substrate may also include an indicia-receiving skin layer positioned on the opposite side of the core layer form the cavitated skin layer. The indicia-receiving skin layer is preferably formed from a polyolefin, e.g. polypropylene, polyethylene, polybutylene or a polyolefinic copolymer or terpolymer. Preferably, the polyolefin of the indicia-receiving skin layer is formed from a polypropylene homopolymer or an ethylene-propylene-butylene terpolymer.

The indicia-receiving uncavitated skin layer may be surface treated by various techniques including for example, flame treatment, corona treatment, plasma treatment or metallizing. This skin layer can also be coated with a suitable primer coating, e.g. polyvinylidene chloride (PVdC) or an acrylic coating, which may be used to provide any or all of the following advantages: enhanced gloss, enhanced compatibility with manufacturing processes and machinery, as well as providing improved barrier properties, such as for instance, improved oxygen barrier, improved water vapor barrier and improved aroma barrier properties; and also enhanced receptivity for printing. Metallizing may be accomplished with various metals including, for instance, aluminum.

The indicia-receiving skin layer may be treated or printed for various purposes. As mentioned, the surface may be flame treated, corona treated or metallized to provide a printable surface for receiving print or images required for packaging and labeling applications. Alternatively, a separate preprinted film may be laminated to the indicia-receiving skin layer. The cavitated surface is receptive for a wide variety of print types, including for example, flexography, photogravure and lithotype, using water or solvent based inks, as well as for inkjet and hot melt printing.

The film structures of the present invention may include a first tie layer separating the core layer and the cavitated skin layer, and a second tie layer separating the core layer and the indicia-receiving skin layer. The first tie layer is preferably cavitated. The tie layers are preferably formed from a polyolefin, and may include one or more whitening agents. Preferably, the tie layers are formed of polypropylene.

Cavitating agents are compounds, usually in the form of particles, that create voids in the thermoplastic layer during stretching in the manufacturing process. By including such particulate material in the polyolefin batch used, the film layer is formed including the particulate material dispersed throughout the layer. Upon orientation of the layer, the dispersed particulate material causes a strata of voids to form at the location of the particulate material. The cavitating agent in the cavitated layer or layers may contribute to the opacity of the film when the polymer layer and the particles of cavitating agent differ in refractive index. Alternatively, transparency of the film structure may be achieve by ensuring that the polymer layer and the particles of cavitating agent have substantially similar or identical refractive indices.

U.S. Pat. No. 4,377,616 to Ashcraft, which discloses cavitated polymer layers of multilayer film structures, is incorporated herein by reference. Briefly, the cavitating agent should be incompatible with the polymer material of the layer in which it is included, such that at the temperature of the extrusion process polymer material of the layer stretches around the particle of the cavitating agent thereby forming a void in the layer. The long axes of the void extend along the stretched directions, i.e. the machine direction (the X direction) and the transverse direction (the Y direction). The Z direction is the axis perpendicular to the plane of the film structure. The particles of the cavitating agent useful in the present invention can be of any particle size ranging from about 0.5μ to about 15μ in diameter. In one embodiment, the median particle size of the cavitating agent is at least about 1.4μ. In another embodiment, the median particle size of the cavitating agent is at least about 3.2μ. In yet another embodiment, the median particle size of the cavitating agent is up to about 3.2μ.

Examples of cavitating agents suitable for use in the films of the present invention include organic or inorganic, particles or powders. The organic or inorganic, particles or powders may be regular or irregular in shape, for instance, the particles may be elongated, planar or spherical. The particles or powders may be composed of materials such as calcium carbonate (CaCO₃, e.g. from aragonite, calcite, chalk, limestone, marble or oyster shells), mica or other minerals, polyamides, polyesters, acetals, acrylic resins (including polymers and copolymers of acrylic acid, methacrylates, acrylic esters an acrylonitrile), nylons, glass particles (including silica), soda ash or lime, solid preformed glass spheres, hollow preformed glass spheres, polybutylene terephthalate (PBT), cyclic olefin polymers and cyclic olefin copolymers (COCs), metal beads, metal spheres, ceramic spheres (especially silicate spheres), ceramic particles, such as ceramic beads, or mixtures of any of the above.

It is contemplated that any layer of the film structure may contain a cavitating agent. CaCO₃ is the preferred cavitating agent. Alternatively, the individual layers may contain two or more cavitating agents. When more than one cavitating agent is present in a single layer, and those agents include CaCO₃, then PBT is not preferred as the second cavitating agent.

In one embodiment, the cavitating agent comprises at least about 25 percent by weight, at least about 35 percent by weight, or at least about 50 percent by weight of the cavitated skin layer. In another embodiment, the cavitating agent comprises up to about 30 percent by weight, up to about 40 percent by weight, up to about 50 percent by weight, or up to about 60 percent by weight of the cavitated skin layer.

In a further embodiment, the cavitating agent may optionally comprise up to about 25 percent by weight, up to about 35 percent by weight, or up to about 50 percent by weight of one, or both independently, of the core layer and the first tie layer, if present.

In particular embodiments, the core layer and one or both tie layers may also be cavitated. In one preferred embodiment, the film structure comprises three or more layers, and the cavitated skin layer and the first tie layer both contain a cavitating agent. In another preferred embodiment, the film structure comprises at least three layers, and the cavitated skin layer, the first tie layer and the core layer each contain a cavitating agent. In another preferred embodiment, the film structure comprises at least three layers, wherein the cavitated skin layer and the adjacent tie layer have the same composition of polymer and the same composition and percentage weight of cavitating agent. In another embodiment, the film structure comprises at least three layers, wherein the core layer includes at least about 4 percent by weight, or at least about 6 percent by weight of a cavitating agent. In another further embodiment, the film structure comprises at least three layers, wherein the core layer includes up to about 10 percent by weight, or up to about 15 percent by weight of a cavitating agent. In one particular embodiment, the film structure comprises at least three layers and includes a core layer with PBT as a cavitating agent. In another particular embodiment, the film structure comprises five layers and includes a core layer with CaCO₃ as a cavitating agent.

The microvoids formed by the cavitating agent may cause perforations and discontinuities in the exposed surface of the cavitated skin layer. These perforations and discontinuities provide a rough and/or porous surface. This surface is suitable as an adhesive-receptive surface, particularly for cold seal adhesives.

The film structures of the present invention may be any thickness suitable for labeling or packaging applications. Preferably, the film structure has a polymer gauge of from about 0.5 mils to about 8 mils, and a caliper gauge of from about 1 mil to about 16 mils. In a particular embodiment, the film structure has a polymer gauge of about 1.5 mils and a caliper gauge of 3.5 mils.

The indicia-receiving skin layer (which is uncavitated) may include an antiblock agent to prevent “grabbing” of the film structure on the machine surfaces and a slip agent to provide better slip on heated metal surfaces and thus enhance machining properties of the film. Antiblock agents include coated silica, uncoated silica and crosslinked silicone. Examples of suitable antiblock agents useful in the films of the present invention also include antiblock agents well known in the art, such as for example, a methyl acrylate such as Epostar® MA 1002 (Nippon Shokubai, Osaka, Japan). Slip agents useful in the present invention are well known in the art and include for instance, silicone oils.

The film structures of the present invention may be clear or opaque. Clear film structures may be achieved by the addition of minimum amounts of a cavitating agent or agents into the core layer and/or the first tie layer. The addition of increasing amounts of cavitating agents to the core layer, or to the core layer and one or both tie layers of the film structures, provides increased opacity of the film.

One or more additives may be optionally added to the core layer; or to the core layer and one or both tie layers; or to the core layer and one or both tie layers and a skin layer. For example, fillers and whiteners, or both may be added to one or more of these layers to provide bright white films. Fillers that may be added to the mentioned layers include any of the fillers which are well known in the art.

Suitable whiteners for use in the film structures of the present invention include but are not limited to white pigments, such as for example TiO₂, CaCO₃, BaSO₄, ZnS, MgCO₃, clay, talc, kaolin, or any other highly reflective white compound. In one embodiment, the core layer includes from about 2 percent to about 10 percent titanium dioxide by weight. In another embodiment, the core layer includes from about 4 percent to about 8 percent titanium dioxide by weight.

Other additives and agents may be suitable for incorporation into one or more layers of the films of the present invention. Additives may be selected from any class of additives, including for example, antioxidants, anti-condensing agents, slip agents, colored dyes, pigments, fillers, foaming agents, flame retardants, photodegradable agents, UV sensitizers or UV blocking agents, crosslinking agents, silicon compounds (e.g. SiO₂) and anti-block agents to name but a few of the many known additives.

Cold seal adhesive is applied to at least a portion of the cavitated skin layer. Cold seal adhesives useful in the practice of the present invention can be any cold seal adhesive, such as an isoprene, natural rubber, neoprene, urethane, acrylic, ethylene vinyl acetate, styrene butadiene rubber, butyl rubber, polyisobutylene rubber, tackified elastomers and ethylene vinyl chloride copolymers. Alternatively, the cold seal adhesive may be any rubber adhesive comprising a mixture of polyisobutylene rubber and butyl rubber dissolved in an organic solvent, such as benzene, toluene, xylene, or hexane; an adhesive obtained by mixing such a rubber adhesive with a tackifier such as abietic acid rosin ester, a terpene-phenol copolymer or a terpene-indene copolymer; with an acrylic adhesive, such as an acrylic adhesive obtained by dissolving an acrylic copolymer such as 2-ethylhexyl acrylate-n-butyl acrylate copolymer or 2-ethylhexyl acrylate-ethyl acrylate-methyl methacrylate copolymer in an organic solvent as listed above. For instance the cold seal adhesive may be a Findley cold seal adhesive, such as Nip-weld C7089, C1099, 210 or 1293 (Findley Inc., Wauwatosa, Wis.).

In the past, cold seal adhesives have traditionally been applied to a film structure after the adhesive-receiving surface of such structure has been modified by a pretreatment technique such as flame treatment or corona treatment, or after the adhesive-receiving surface has been precoated. These pretreated and precoated surfaces are referred to herein as modified surfaces. Surprisingly, the film structures of the present invention receive the cold seal adhesive without the need for such surface treatment. It is believed that the cavitated skin layer provides a porous surface layer to which the cold seal adhesive can readily adhere even in the absence of surface treatment.

The cavitated skin layer of the film structures of the present invention can be coated with cold seal adhesive over the entire surface of the cavated skin layer. Alternatively, the cavitated skin layer of the film structures can be partially coated with cold seal adhesive to provide sealability over a limited area of the cavitated surface. In the film structures of the present invention cold seal adhesive coating coverage can be any coverage suitable to achieve the adhesive properties described herein. In a particular embodiment, the coverage of the cold seal adhesive coating is from about 1 gm/1000 in² to about 5 gm/1000 in². In another embodiment, the coverage of the cold seal adhesive coating is from about 2 gm/1000 in² to about 3 gm/1000 in².

Such limited coverage of cold seal adhesive may be useful in providing packaging of a product with the partially or fully enclosed lumens formed by the sealed films of the invention, such as, for instance, bubbles, pockets, tubes, or other seals over limited areas of the film, as exemplified in U.S. Pat. No. 6,099,682 to Krampe et al. for comestible products, and in U.S. Pat. No. 6,199,698 to Hetrick et al. for pharmaceutical products. The specifications of these patents are hereby incorporated by reference.

The present invention also provides a method of wrapping or enclosing a product or product container within an adhesive coated sealable thermoplastic film of the present invention as described above and contacting two areas of a cold seal adhesive coated skin layer of the film to form an adhesive bond, such that the product or product container is wrapped, enclosed, or partially of totally covered by the film, and opening of the sealed structure results in visible delamination of the cavitated skin layer thus providing evidence of tampering.

The film structures of the present invention may be used as linerless pressure sensitive labels that adhere to the surface of a product to be labeled when pressed against such surface. Particularly, the film structures of the present invention are useful for labeling of products or containers for products, such as bottles, cans, vials, cartons, sachets and pouches. The surface of the product or container to be labeled may be formed from glass, plastic, rubber, synthetic resins, ceramic or other porous or non-porous materials.

The film structures may be formed into labels with a cold seal adhesive coating over all or a portion of the cavitated film surface. The film structures used for labeling may be clear or opaque, printed or plain. Furthermore, the labels may be glossy or matte, pigmented or unpigmented, white or colored.

The adhesive-coated thermoplastic film structures of the present invention are pressure sealable. The film structures may be pressed onto the surface of a product for labeling or sealed by pressing two adhesive-coated surfaces together. When the adhesive sealed film structures are separated, delamination of the skin layers occurs, leaving the adhesive layer remaining intact and unbroken. This delamination is easily detectable and thereby prevents unobtrusive opening and resealing and provides visible evidence of any tampering with the seal.

It has been discovered herein that the cold seal adhesive-coated film of the present invention may be rolled, and thereafter unrolled without adherence of the cold seal adhesive to the indicia-receiving skin layer. Thus, the present film structures may be rolled for storage or transport without the use of a liner to separate the adhesive-coated and uncoated surfaces of the film structure, and then unrolled prior to its use in packaging or labeling processes.

The film structures of the present invention may be provided with a releasable liner for covering the adhesive-coated cavitated skin layer during storage and shipping. Liners for adhesive-coated films are also generally useful in protection of the adhesive surface of the film structure during pretreatment steps, such as during preparation, cutting, printing, handling and dispensing of the film.

The present invention further provides a method of labeling a product or product container by (a) contacting a product with the cold seal adhesive of an adhesive coated sealable polymeric film structure of the present invention as described above; and (b) applying pressure to the film structure to form an adhesive bond between the film structure and the product, thereby affixing the label directly to the product.

The label may be any type of label, such as for instance, labeling tape, bar coding labels, emblems, badges, decals, tags, signs and stickers. The product to be labeled may be any product to which a label may be directly affixed, such as for instance, hardware items. Alternatively, the label may be affixed to a product container. The product container may be any type of product container, including but not limited to bottles, vials, jars, boxes and wrapping. These product containers may be formed from any of a wide variety of materials including such materials as glass, ceramic, plastic, paper, card, cardboard and wood.

### EXAMPLES

Film structures according to the present invention were produced having the compositions and properties as recited below. In Examples 1 and 2, the polypropylene (PP) was Exxon 4612 (Trademark of ExxonMobil); the polybutlene terephtalate (PBT) cavitating agent was Ticona 1300A (Trademark of Ticona); and the CaCO₃ was Omyacarb FT (Trademark of Omyacarb) having a median particle size of 1.4μ. Any isotactic PP such as for instance Fina 3371 (Trademark of Fina); or any HCPP, such as for instance Amoco 9117 (Trademark of Amoco) may be substituted for the PP. Any cavitating formulation, such as a COC, for instance Ticona Topas 6017 (Trademark of Ticona) may be substituted for the cavitating agent.

### Example 1

The film is a three layer film with the following compositions and dimensions:

| % Total Film Thickness | Layer composition |
|---|---|
| 15 | Homopolymer PP skin |
| 70 | Cavitated PP Core (+PBT) |
| 15 | Homopolymer PP (+50% CaCO₃) skin |
| | ---------------------------------------------------- |
| | This surface coated with cold seal adhesive |

### Example 2

The film is a three layer film with the following compositions and dimensions.

| % Total Film Thickness | Layer composition |
|---|---|
| 15 | Homopolymer PP skin |
| 70 | Cavitated PP Core (+PBT) |
| 15 | Homopolymer PP (+25% CaCO₃) skin |
| | ---------------------------------------------------- |
| | This surface coated with cold seal adhesive |

### Example 3

In this example of a further particular embodiment, the following film structure was sampled with cold seal adhesive on the surface of the cavitated skin layer.

The five layer film structure included a cavitated adhesive-receptive homopolymer skin layer, an adjacent tie layer that is cavitated, a cavitated core layer, a second tie layer that is uncavitated and a copolymer skin layer. The core layer, which was formed from PP (Exxon 4612), contained PBT (Ticona 1300A) cavitating agent and CaCO₃ (Ampacet Pearl 2, with a particle size range of about 0.6μ to about 10μ). The tie layer adjacent the homopolymer skin layer contained CaCO₃, (Ampacet Pearl 70, with a particle size range of about 0.6 μto about 8μ). The reported particle sizes of the cavitating agents were from Hegdman grind determinations in which the percentage of particles that come through each of a series of screens or sieves, each having a particular mesh size. The homopolymer skin layer has an identical composition to the adjacent tie layer.

Copolymer Skin
Homopolymer PP Tie Layer
Cavitated Core (PP + 7% CaCO₃ -Pearl 2)
Homopolymer Tie Layer + 35% CaCO₃ -Pearl 70
Homopolymer Skin with 35% CaCO₃ -Pearl 70
-----------------------------------------------------------
This surface coated with cold seal adhesive

Samples of the film were coated with cold seal adhesive using Mayer rod drawdowns, with surprising results demonstrating unexpected beneficial properties. Typically the coating weight of cold seal adhesive was about 2.5 gms/1000 in².

After drying, the samples were tested by applying hand pressure, glue surface to glue surface. When the samples were separated, reasonable resistance was encountered and then fiber tear was noted.

To verify these results, the samples were sealed on the Wrap-Ade (See Example 3, above for conditions) in the laboratory, and then peak seal strength of the seals were assessed by pulling the films on an Sintack Tensile type tester instrument, using Testworks software by MTS.

Peak seal strength ranged from 345 gm/in. to 443 gm/in. Typical cold seal minimum requirements are 400 g/in. with 100% Z-tear. The seal strength decreased to a range of 222 to 285 g/in, which appears to be the cohesive strength of the cavitated layers, giving the fiber tear/delamination. This fiber tear, or delamination offers the tamper evidence characteristic of the films of the present invention.

Crimp Seal Strength Testing

Crimp seal strength was evaluated by inserting the test film squarely between the jaws of a “WRAP-ADE” crimp sealer so that the transverse direction of the film was parallel to the jaws. The seal was formed and then tested by pulling the sealing surfaces away from each other.

The film was sealed with a Wrap-Ade at 80 psi with ½ sec dwell at ambient temperature. The following table show results from a Syntack Tensile test experiment run at 12 inches per minute, with 5 lbs load cell and a 1 inch jaw gap. The experiment was run with different cold seal adhesive loadings on the film structure as follows:

| | Peak Seal Strength | Average seal |
|---|---|---|
| | g/in (Initial Z- | strength g/in (Z- |
| | failure) | tear) |
| Cavitated Skin vs. 610 tape | 148 | 33 |
| Cavitated Skin with Cold Seal | 345 | 278 |
| #0 Mayer rod | | |
| Cavitated Skin | 374 | 285 |
| with #3 Mayer rod | | |
| Cavitated Skin | 443 | 222 |
| with #5 Mayer rod | | |

The 610 tape adheres strongly to the cavitated skin layer of the tested film structure, providing a high tear strength bond to the test film structure and also provides a tab for gripping and pulling by the jaws of the Instron in the Z-direction (perpendicular to the plane of the film).

The Instron pulls on the tab of 610 tape and records the force required to initiate the tearing of the film in the Z-direction as the peak seal strength. The average force required to pull the film apart after the initial Z-tear is recorded as the average seal strength. The peak seal strength is generally significantly higher than the average seal strength, reflecting the greater force required to initiate failure of the film layers than the force required to continue the fiber tear or delamination of the film structure once initiated. Mayer rods #0, #3 and #5 provide increasing cold seal adhesive coating densities over the coated surface of the film structure being tested. In an alternative mode, the tensile strength test may be run according to standard procedures well known to those of skill in the art, such as for instance, ASTM D638 (as disclosed on the internet website: www.matweb.com/measurements/tensilestrength/htm).

What is claimed is:

1. An oriented polymeric film structure, comprising:
a substrate having a cavitated skin layer adhered thereto, said cavitated skin layer being coated at least in part with a cold seal adhesive.

2. The structure according to claim 1, wherein the outer surface of said cavitated skin layer is unmodified.

3. The structure according to claim 1, wherein said cavitated skin layer comprises up to about 50% by weight of a cavitating agent.

4. The structure according to claim 2, wherein said substrate comprises a core layer and a first tie layer, said first tie layer being positioned between said core layer and said cavitated skin layer, said first tie layer being cavitated.

5. The structure according to claim 4, wherein said cavitated skin layer and said first tie layer each comprise up to about 50 percent by weight of a cavitating agent.

6. The structure according to claim 4, wherein said substrate further comprises a second tie layer and an indicia-receiving skin layer, said second tie layer being positioned between said core layer and said indicia-receiving skin layer and being located on the opposite side of said core layer from said first tie layer.

7. The structure according to claim 6, wherein said substrate and said cavitated layer are coextruded, and wherein said coextruded structure is stretched from about 3.5 to about 6.0 times in the machine direction and from about 7 to about 10 times in the transverse direction.

8. The structure according to claim 6, wherein said indicia-receiving skin layer includes an antiblock agent and/or a slip agent.

9. The structure according to claim 8, wherein said antiblock agent and/or slip agent comprises one or more antiblock agents and/or slip agents selected from the group consisting of coated silica, uncoated silica, silicone oil and crosslinked silicone.

10. The structure according to claim 6, wherein said cavitated skin layer and said first tie layer each include a cavitating agent, said cavitating agent comprising calcium carbonate.

11. The structure according to claim 10, wherein said cavitated skin layer and said first tie layer each include at least about 35% by weight of said cavitating agent.

12. The structure according to claim 11, wherein said core layer is cavitated.

13. The structure according to claim 6, wherein said indicia-receiving skin layer comprises a polyolefinic copolymer, and wherein said cavitated skin layer, said core layer and said tie layers comprise a polyolefinic homopolmer.

14. The structure according to claim 13, wherein said copolymer comprises propylene-ethylene and said homopolymer comprises polypropylene, and wherein said cavitated skin layer and said first tie layer each include at least about 35% by weight of a cavitating agent.

15. The structure according to claim 14, wherein said substrate layer and said cavitated layer are coextruded, and wherein said coextruded structure is stretched from about 3.5 to about 6 times in the machine direction and from about 7 to about 10 times in the transverse direction.

16. A method of packaging a product to provide a tamper-evident packaging, comprising:
(a) providing a polymeric film structure having a cavitated skin layer, the cavitated skin layer having an outer surface coated at least in part with a cold seal adhesive;
(b) wrapping said film structure around a product;
(c) sealing said film structure around said product by contacting a first portion of said cold seal adhesive with a second portion of said cold seal adhesive to form a sealed film structure enclosing said product whereby opening of said sealed film structure results in visible delamination of said cavitated skin layer thus providing evidence of tampering.

17. The method according to claim 16, wherein said film structure includes an indicia-receiving surface opposite said cavitated skin layer, and further comprising the step of applying printing directly on said indicia-receiving surface.

18. A method of labeling a product, comprising:
(a) providing a polymeric film structure having a cavitated skin layer and an opposing indicia-receiving surface, said cavitated skin layer having an outer surface coated with a cold seal adhesive;
(b) applying printed indicia to said indicia-receiving surface to provide a pressure sensitive label; and
(c) pressing said adhesive-coated cavitated skin layer against said product whereby said label adheres to said product.

19. The method according to claim 18, wherein said applying step includes the step of printing directly on said indicia-receiving surface.

20. The method according to claim 18, wherein said applying step includes the step of laminating a printed film to said indicia-receiving surface.
